(19) United States
(12) Patent Application Publication
(10) Pub. No.: US 2007/0053394 A1
(43) Pub. Date: Mar. 8, 2007

(54) Cooling device using direct deposition of diode heat pump

(76) Inventor: Isaiah Watas Cox, Baltimore, MD (US)

Correspondence Address: Borealis Technical Limited, 23545 NW Skyline Blvd, North Plains, OR, 97133-9204, US

(21) Appl. No.: 11/517,060

(22) Filed: Sep. 6, 2006

(30) Foreign Application Priority Data
Sep. 6, 2005 (GB) GB0518132.6

(51) Int. Cl. H01S 3/04

(52) U.S. Cl. 372/34

(57) ABSTRACT

A diode heat pump is disclosed which may be deposited directly onto a processor unit using thin-film deposition techniques to achieve more efficient cooling. The diode heat pump is either formed in situ on the processor unit or attached to the processor unit after each unit has been manufactured. Further embodiments of diode heat pumps are also disclosed.

### CROSS-REFERENCE TO RELATED APPLICATIONS

This application claims the benefit of U.K. Provisional Patent App. No. GB0518132.6, filed Sep. 6, 2005.

### BACKGROUND OF THE INVENTION

This invention relates generally to cooling of electronic devices using diode heat pumps.

Definitions:

“Cool Chip” is hereby defined as a device that uses electrical power or energy to pump heat, thereby creating, maintaining, or degrading a thermal gradient. Cool Chips may accomplish this using thermionics, thermotunneling, or other methods as described in this application. It is understood that the present invention relates to Cool Chips.

“Gap Diode” is defined as any diode which employs a gap between the anode and the cathode, or the collector and emitter, and which causes or allows electrons to be transported between the two electrodes, across or through the gap. The gap may or may not have a vacuum between the two electrodes, through Gap Diodes specifically exclude bulk liquids or bulk solids in between the anode and cathode. The Gap Diode may be used for Cool Chips and for other diode applications. In the present invention of a diode heat pump is used as the means for producing cooling. The example of a diode heat pump is used henceforth as one model of all relevant diode applications. It is understood that all further references using the term ‘diode heat pump’ include all relevant diode applications using thermotunneling and/or thermionic emission.

“Matching” surface features of two facing surfaces of electrodes means that where one has an indentation, the other has a protrusion and vice versa. Thus, the two surfaces are substantially equidistant from each other throughout their operating range.

Heat generated during processor operation may adversely affect the processor's performance and may damage the processor. Thus, it is desirable to keep processors and other heat generating electronic devices cool. Cooling processors may increase processor performance and decrease the potential for damage.

Traditional methods of cooling may either be impractical for use with small devices, such as microprocessors, or may be practical but inefficient. For example, cooling a processor by conduction may not produce sufficiently low temperatures due to resistance from the components used in the cooling process. Moreover, refrigeration cooling may produce sufficiently cool temperatures but the volume of cooling solution and amount of accompanying hardware do not make this system practical for use with small devices, such as a microprocessor.

Thermoelectric cooling, for example by a Peltier device, may be practical for use in small electronic devices because the Peltier devices are compact. Generally, when a current is applied to a Peltier-type thermoelectric cooling device, it will absorb heat from one surface of the electronic device and release the heat somewhere else.

However a significant disadvantage of using thermoelectric systems for cooling electronic enclosures in general has been the dismal level of efficiency. The best thermoelectric systems can only provide around a 5-8% Carnot efficiency. This is because all free electrons around and above the Fermi level take part in current transport through the thermoelectric material, but it is only high energy electrons that are efficiently used for cooling. Thermoelectric cooling devices have high thermal conductivity due to the layers of insulating material which causes a large thermal backpath and hence a low level of efficiency. Recent attempts have been made to find materials which conduct electricity but thermally insulate.

A recent example, disclosed in U.S. Pat. No. 6,365,821, is a thermoelectric cooler utilizing superlattice and quantum-well materials which have higher ZT values, and thus, may produce more efficiency than traditional thermoelectric coolers. Furthermore, when the thermoelectric cooler is deposited directly onto a die using thin-film deposition techniques there is a substantial reduction in temperature at the die/thermoelectric cooler interface so the leakage power consumption of the die is also reduced. This and other new approaches have managed to increase cooling efficiency somewhat. But even the best thermoelectric systems only provide around a 35% efficiency rating because the mere presence of insulating layers obstructs heat transfer.

Furthermore, in general, thermoelectric coolers require a lot of power with high manufacturing cost per watt pumping capacity and are prone to overheating. Most cooling systems use compressors and environment-damaging fluids. Thermoelectric coolers also have very high toxicity and although their overall reliability is high, this is only the case when they are within their limited temperature regions of between approximately −200 and 200 degrees Celsius thereby requiring higher maintenance when used for higher temperatures.

U.S. Pat. No. 6,876,123 discloses a thermotunneling device comprising a pair of electrodes having inner surfaces substantially facing one another, and a spacer or plurality of spacers positioned between the two electrodes, having a height substantially equal to the distance between the electrodes. In a preferred embodiment, a vacuum is introduced, and in a particularly preferred embodiment, gold that has been exposed to cesium vapor is used as one or both of the electrodes. FIG. 1 shows a diagrammatic representation of one embodiment of a diode heat pump. An emitter electrode 30 and a collector electrode 26 are separated by a gap 28 through which electrons tunnel. In a preferred embodiment, electrodes 26 and 30 are smooth. In a further preferred embodiment, electrodes 26 and 30 are close-spaced. In a further preferred embodiment, electrodes 26 and 30 are matching.

In WO03/083177, the use of electrodes having a modified shape and a method of etching a patterned indent onto the surface of a modified electrode, which increases the Fermi energy level inside the modified electrode, leading to a decrease in electron work function is disclosed. FIG. 2 shows the shape and dimensions of a modified electrode 18 having a thin metal film 40. Indent 44 has a width b and a depth Lx relative to the height of metal film 40. Film 40 comprises a metal whose surface should be as plane as possible as surface roughness leads to the scattering of de Broglie waves. Metal film 40 is given sharply defined geometric patterns or indent 44 of a dimension that creates a De Broglie wave interference pattern that leads to a decrease in the electron work function, thus facilitating the emissions of electrons from the surface and promoting the transfer of elementary particles across a potential barrier. The surface configuration of modified electrode 18 may resemble a corrugated pattern of squared-off, “u”-shaped ridges and/or valleys. Alternatively, the pattern may be a regular pattern of rectangular “plateaus” or “holes,” where the pattern resembles a checkerboard. The walls of indent 44 should be substantially perpendicular to one another, and its edges should be substantially sharp.

FIG. 3 shows a diagrammatic representation of a process for building one embodiment of a diode heat pump as disclosed in U.S. Pat. No. 6,876,123 mentioned above. In a step 100, the surface of electrode 30 comprising a silicon wafer is oxidized to create a thin oxide film 46. Preferably, film 46 has a thickness of the order of 10 nm. In a step 110, an array of small dots 48 is created on the surface. This step may be accomplished for example and without limitation by standard photolithographic processes. In a step 120, the oxide material 46 between spacers 48 is removed, for example, by an etching process. In a step 130, electrode 26 comprising a second, matching silicon wafer, is bonded to the top of spacer array 48 maintaining a gap 28 through which electrons can pass. Thus, diode heat pump 16 is constructed. This device can be constructed using micromachining or other methods and can be made cheaply, quickly and easily.

The mechanical properties of silicon are such that if a small particle is trapped in between two silicon wafers, a non-bonded area (void) of 5000 times the size (height) of the particle is created. Therefore the spacers consisting of a dot of silicon oxide topped by a protective layer will have the effect of keeping the two silicon wafers at a desired distance without the use of active elements to maintain the gap 28, making the design very inexpensive and thus extremely suitable for efficient cooling. In a preferred embodiment the surface between the spacers has an indented structure and comprises a thermionic device. In a second embodiment device shown in FIG. 3 is a thermotunneling device.

U.S. Pat. No. 6,720,704 discloses diode heat pump devices in which the separation of the electrodes is set and controlled using piezo-electric, electrostrictive or magnetostrictive actuators. Pairs of electrodes whose surfaces replicate each other are also disclosed. These may be used in constructing devices with very close electrode spacings. FIG. 4 shows a diagrammatic representation of one embodiment of the electrode configuration of a diode heat pump showing piezo-electric actuators at intervals along the under-surface of electrode 26. Two electrodes 26 and 30 are separated by a region 28. Electrode 30 is attached to a number of piezo-electric actuators 60 at intervals. An electric field is applied to the piezo-electric actuators via connecting wires 68 which causes them to expand or contract longitudinally, thereby altering the longitudinal distance of region 28 between electrodes 26 and 30. Electrodes 26 and 30 are connected to capacitance controller 62 which both modifies the piezo-electric actuator 60 and can give feedback to a power/supply/electrical load 64 to modify the heat pumping action, and generating action, respectively. The longitudinal distance of region 28 between electrodes 26 and 30 is controlled by applying an electric field to piezo-electric actuators 60. The capacitance between emitter 30 and collector 26 is measured and controlling circuitry 62 adjusts the field applied to piezo-electric actuators 60 to hold the capacitance, and consequently the distance between the electrodes 28 at a predetermined fixed value. Alternatively, the controller 62, may be set to maximize the capacitance and thereby minimize the distance 28 between the electrodes.

WO03/090245 discloses a diode heat pump in which a tubular actuating element serves as both a housing for a pair of electrodes and as a means for controlling the separation between the electrode pair. In a preferred embodiment, the tubular actuating element is a quartz piezo-electric tube. Preferred embodiments of thermotunneling converters include Cool Chips, Power Chips, and photoelectric converters. FIG. 5 shows an embodiment of a diode heat pump 16 constructed by bonding together a composite of a silicon wafer 58, electrodes 26 and 30 and a copper layer 56 with a composite of electrically conducting paste 54 and substrate 52 with high pressure. An opening or gap 28 is then created between matching electrodes 26 and 30 by the use of heat. Gap 28 is controlled and maintained by actuators 50 which also serve as housing.

U.S. Pat. No. 6,869,855 discloses methods for making matching electrode pairs. FIG. 6 shows a diagrammatic representation of a process for building matching electrode pairs. The method involves fabricating an electrode pair precursor sandwich 90. Sandwich 90 consists of a first layer of material 80 suitable to act as a first electrode on top of which a sacrificial layer 82, which comprises a material of low work function such as cesium, is deposited. Another layer of material 86 is electrochemically grown on top of sacrificial layer 82. Layer 86 is a material suitable to form a second electrode in the finished electrode pair. In step 200 sandwich 90 is heated up to a temperature greater than the melting temperature of sacrificial layer 82 but which is lower than the melting temperature of layers 80 and 86. Layer 82 will therefore vaporize leaving gap 88 through which electrons can tunnel, forming a diode heat pump 16

### BRIEF SUMMARY OF THE INVENTION

From the foregoing, it may be appreciated that a need has arisen to provide more advanced methods of cooling with higher efficiency and a broader range of applications; specifically, being efficient and practical for use in small electronic devices. In general terms, the present invention uses the direct deposition of diode heat pump devices to cool electronic devices. Accordingly, several objects and advantages of the present invention are as follows:

An advantage of diode heat pumps is that they do not have any barriers between the electrodes. There is a physical gap between the electrodes. This solves the problem of substantial thermal flow of heat due to the layers of insulating material resulting in the low level of efficiency of thermoelectric coolers, as a gap is a significantly better thermal insulator than any solid because it presents no obstacle for tunneling electrons. Use of thermotunneling in a diode heat pump thereby eliminates a substantial proportion of heat conduction and creates more efficient cooling than thermoelectric coolers or other cooling devices.

In the present invention a diode heat pump is formed directly on the processor thereby comprising a hybrid composite unit. The deposition of the diode heat pump onto the processor is performed at an atomistic level such that the first layer of the diode heat pump and the surface of the processor unit are effectively integral. This results in a substantial reduction in temperature at the interface between the processor and the diode device, reducing the leakage power consumption of the die and hence increasing the cooling efficiency. Furthermore, due to its compactness, the thin-film diode heat pump may contribute to a compact package height that is ideal for use in microprocessors and has a broader range of applications.

In a first embodiment of the present invention, the diode heat pump is formed in situ on the processor during the process used to form the processor. A layer of material suitable for use as a first electrode is deposited directly onto the processor to be cooled using deposition techniques known to the art, including for example and without limitation, techniques such as molecular beam epitaxy (MBE) and metal organic vapor deposition (MOCVD). The diode heat pump is constructed thereon.

In a second embodiment of the present invention the diode heat pump is attached to the processor unit after each unit has been manufactured independently.

The diode heat pump used in the present invention may comprise a pair of electrodes separated by a gap through which electrons can tunnel, as disclosed in FIG. 1 above.

In another embodiment the first electrode of the diode heat pump is modified with patterned indents to increase the metal's Fermi level, lower its work function and thereby increase the flow of electrons across the barrier, as disclosed in FIG. 2 above. In the first embodiment of the present invention the electrode is modified following its deposition onto the processor. In the second embodiment the diode heat pump is manufactured independently utilizing the modified electrode and is then attached to the processor.

In further embodiments the gap between the electrodes is maintained by spacers, as disclosed in FIG. 3 or controlled and set by actuators as disclosed in FIGS. 4 and 5.

In yet a further embodiment the diode heat pump is constructed by fabricating an electrode pair precursor sandwich, as disclosed in FIG. 6 above, comprising two electrodes with a sacrificial layer between them. The sandwich is treated, thereby removing the sacrificial layer and forming a separation between the electrodes at a distance that enables maximum thermotunneling or thermionic emission to occur. In the first embodiment of the present invention a first layer of material suitable for use as a first electrode is deposited onto the processor as disclosed. The sandwich is thereon and then separated, as disclosed. In the second embodiment, the sandwich is constructed, as disclosed, attached to the processor and then separated forming a completed diode heat pump.

An advantage of using a diode heat pump is that, due to its compactness, the thin-film diode heat pump may contribute to a compact package height that is ideal for use in small electronic devices. There is no toxicity in the present invention, it has a very long lifespan and very high overall reliability as diode devices are extremely robust compared to Peltier/thermoelectric devices which have high overall reliability only within their temperature regions. The operating temperature region of diode heat pumps in the present invention may be −272 to 1000 degrees C., they are much cheaper to produce and maintain and they are projected to provide 50-70% of Carnot efficiency.

The use of a diode heat pump as the cooling mechanism and forming it directly onto the processor results in substantially increased cooling efficiency and the die may maintain a cooler operating temperature. Hence, the performance of the electronic device is improved and it is prevented from sustaining damage.

Further objects and advantages of this invention will become apparent from a consideration of the figures and the ensuing descriptions.

### BRIEF DESCRIPTION OF THE SEVERAL VIEWS OF THE DRAWING

Embodiments of the invention will now be described with reference to appropriate figures, which are given by way of an example only and are not intended to limit the present invention. For a more complete explanation of the present invention and the technical advantages thereof, reference is now made to the following description and the accompanying drawings, in which:

FIG. 1 is a greatly enlarged view of one embodiment of a prior art diode heat pump;

FIG. 2 is a reduced view of a prior art modified electrode for use in one embodiment of a diode heat pump in the course of fabrication. An indent is etched on the film deposited on the die;

FIG. 3 is a diagrammatic representation of a prior art process for building one embodiment of a diode heat pump;

FIG. 4 is a diagrammatic representation of the prior art electrode configuration of a diode heat pump, showing piezo-electric actuators at intervals along the under-surface of an electrode;

FIG. 5 is a diagrammatic representation of a prior art diode heat pump having a tubular actuator;

FIG. 6 is a diagrammatic representation of a prior art process for building matching electrode pairs for use in a diode heat pump;

FIG. 7 is a diagrammatic representation of a processor/coolchip device;

FIG. 8 greatly enlarged view a packaged device of the present invention;

FIG. 9 is a diagrammatic representation of a processor/coolchip device utilizing one embodiment of a diode heat pump;

FIG. 10 is a diagrammatic representation of a first embodiment of the process for building a processor/coolchip device. The diode heat pump is constructed in situ on top of the die; and

FIG. 11 is a diagrammatic representation of a second embodiment of the process for building a processor/coolchip device. The diode heat pump is manufactured independently and then attached to the die.

### DETAILED DESCRIPTION OF THE INVENTION

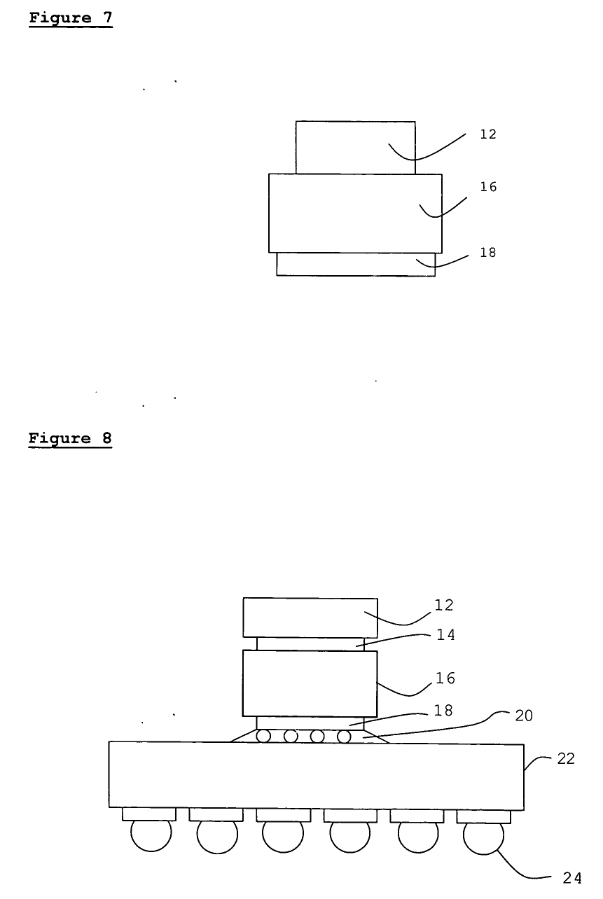

The present invention is referred to in FIGS. 7 to 11.

FIG. 7 is a diagrammatic representation of a processor/coolchip device, a processor unit 18 having one or more surfaces to be cooled is in thermal contact with a diode heat pump 16, which pumps heat produced by the processor to heat sink 12. For the sake of clarity, FIG. 7 shows only one surface of the processor in thermal contact with a diode heat pump. The processor may be any processor unit, including but not limited to: central processor units, embedded processors, microprocessors, microcontroller units and digital signal processors. Typically processor unit 18 is a die formed in or on a package. A number of packaging formats are known to the art, for example an organic land grid array package (OLGA). Alternatively other packaging techniques may be utilized. Several embodiments of diode heat pump 16 may be used as disclosed above. It is understood that the present invention includes but is not limited by these embodiments.

In a first embodiment of the present invention diode heat pump 16 is formed in situ with die 18. In a second embodiment diode heat pump 16 is constructed independently and then attached to die 18.

Use of diode heat pump 16 greatly increases cooling efficiency as the physical gap between the electrodes reduces the thermal backflow. Furthermore, the direct deposition of diode heat pump 16 onto die 18 greatly reduces thermal resistance and leakage at the heat pump 16/die 18 interface thereby producing greater cooling efficiency.

Referring now to FIG. 8, which shows a packaged device of the present invention, die 18 having a surface to be cooled is in thermal contact with diode heat pump 16 and is coupled onto package 22 by a layer of underfill 20. Solder bumps 24 may be used to electrically and mechanically couple the die 18 to a circuit board (not shown) using surface mount techniques. A thermal interface material 14 may be positioned between diode heat pump 16 and a heat sink 12. The heat sink may be a conventional finned heat sink, other forms of air-cooled heat sinks such as one with stampings, extrusions or castings, a conventional heat pipe or one with variable thermal conductance, or a liquid cooled device, or any other device known to those in the art. Thus., diode heat pump 16 pumps heat away from the die 18 to the heat sink 12 and heat produced by the die 18 may be continually removed by maintaining a temperature gradient across diode heat pump 16. Thus, die 18 is kept cool, preventing it from sustaining damage and/or improving its performance.

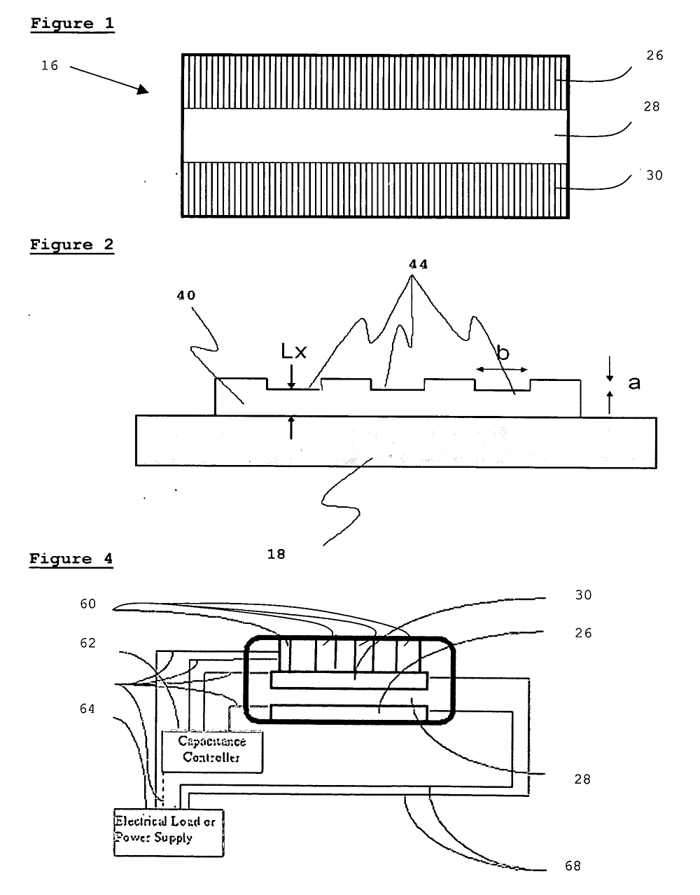

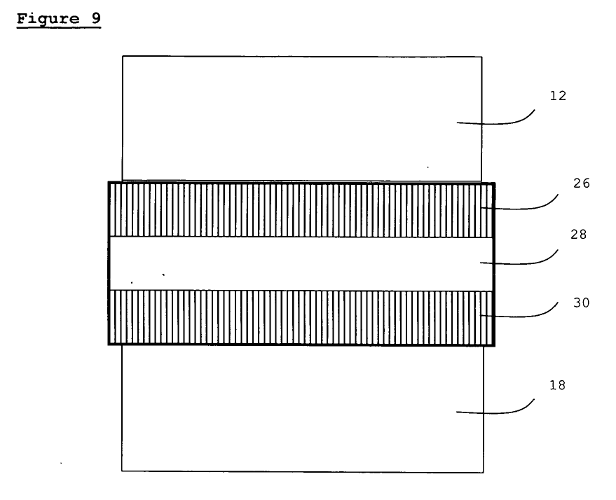

FIG. 9 is a diagrammatic representation of a processor/coolchip device utilizing the embodiment of diode heat pump 16 shown in FIG. 1. Alternatively further embodiments as disclosed in prior art and embodiments known to those in the art may be used. It is understood that the present invention is not limited to those embodiments. Thus, diode heat pump 16, comprising electrodes 30 and 26 substantially facing each other with a gap 28 between them through which electrons can tunnel as disclosed above, is deposited onto die 18. Heat produced is pumped to heat sink 12.

As disclosed, there are two general embodiments for the process of constructing the present invention. In a first embodiment diode heat pump 16 is fabricated in situ on top of the finished die 18. In a second embodiment diode heat pump 16 may be attached to die 18 after the two units have been independently manufactured.

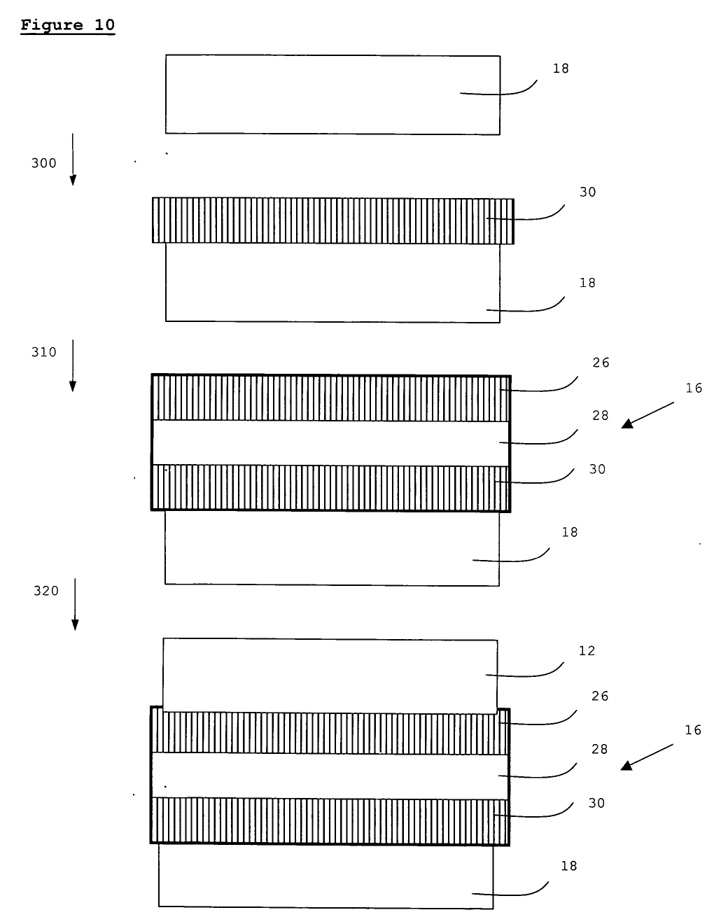

FIG. 10 shows a first embodiment of the present invention in which the diode heat pump is constructed in situ on top of the die.

In step 300 a material suitable for being a first electrode 30 is deposited directly onto die 18. In step 310 the construction of diode heat pump 16 is completed. A second electrode 26 is positioned such that electrodes 30 and 26 are separated by a gap 28 through which electrons can tunnel. In step 320, heat sink 12 is attached to diode heat pump 16 so that heat produced by die 18 can be continually pumped away.

Direct deposition of electrode 30 onto die 18 may be done using techniques such as molecular beam epitaxy (MBE) and metal organic chemical vapor deposition (MOCVD). MBE and MOCVD are vapor deposition techniques used to deposit layers of materials on a substrate at the atomistic level. These techniques are chosen because of the precise control that they give over deposition of thin films. Other examples include approaches commonly used in the art. It is understood that the invention is in no way limited to these specific methods and they are mentioned only by way of example.

Because MBE or MOCVD may be employed to deposit electrode 30, there is no need for the use of thermal interface material between diode heat pump 16 and die 18. That is, because electrode 30 may be deposited onto die 18 at the atomistic level, there is no need for an interface material. Moreover, because diode heat pump 16 and die 18 are effectively integral, forming a hybrid composite unit, there is little, if any, interfacial resistance to thermal conduction. Thus, die 18 may maintain a cooler operating temperature. Furthermore, due to its compactness, thin-film diode heat pump 16 may contribute to a compact package height that is ideal for use in small electronic devices.

In FIG. 10 diode heat pump 16 as disclosed in U.S. Pat. No. 6,876,123 shown in FIG. 1 is used. Alternatively further embodiments as disclosed in prior art and embodiments known to those in the art may be used. It is understood that the present invention is not limited to those embodiments. Due to gap 28 there are no intermediary insulating layers of material, which reduces the thermal flow of heat because it presents no obstacle for tunneling electrons thus increasing efficiency.

Alternatively diode heat pump 16 can be as disclosed in WO03/083177, shown in FIG. 2 above, with a modified electrode 40 to increase the electrode's Fermi level and thereby increase the electron flow. In this embodiment thermionic emission may used as the preferred embodiment. In the present invention modified electrode 40 shown in FIG. 2 comprises a thin metal film that is modified, as disclosed, following its deposition onto die 18. Diode heat pump 16 is then completed using modified electrode 40 as the initial layer, as disclosed above.

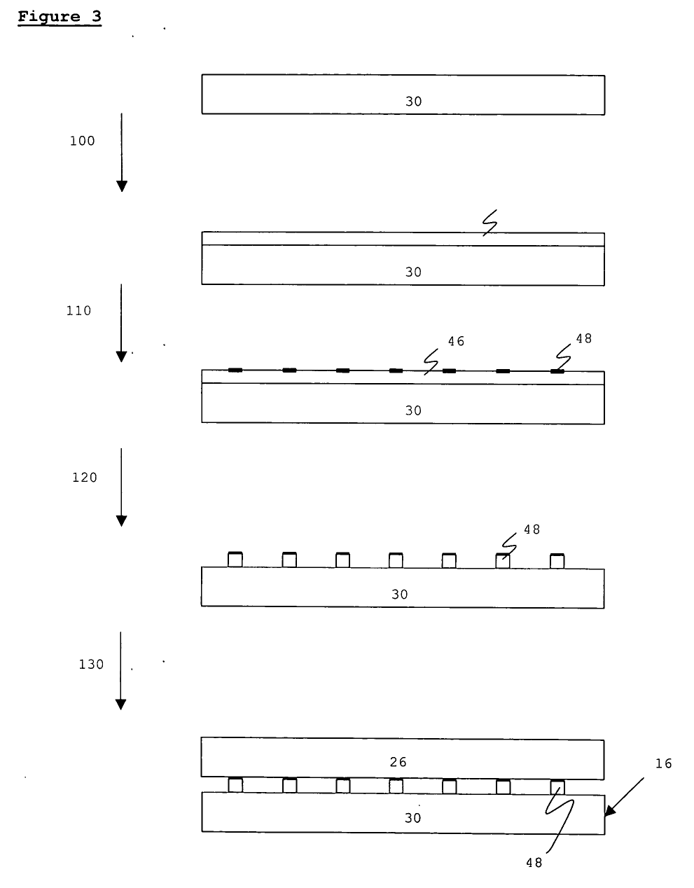

Gap 28 may be controlled and maintained using several techniques represented in the Figures shown above. For example, in one embodiment diode heat pump 16 is constructed using the process shown in FIG. 3 above, as disclosed in U.S. Pat. No. 6,876,123, in which spacers maintain gap 28.

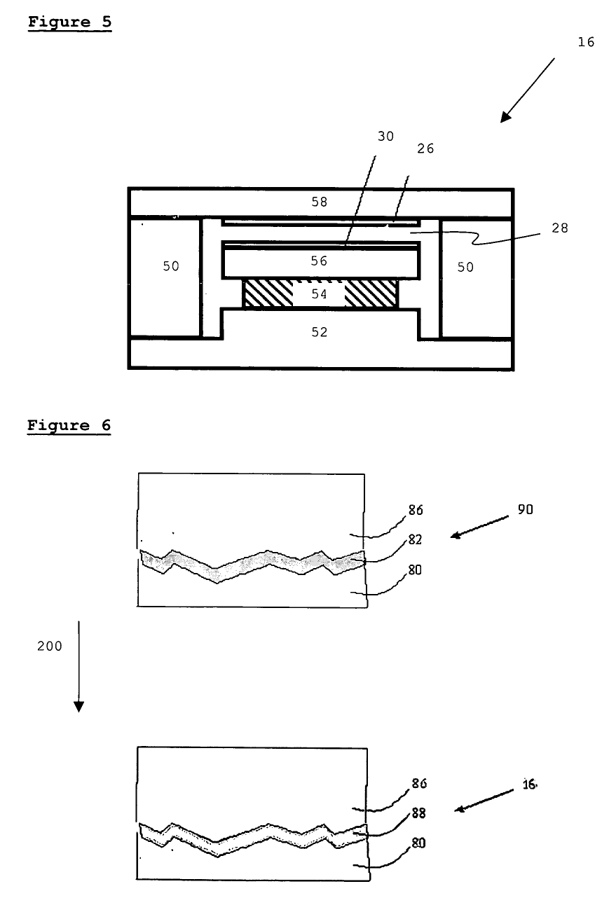

In another embodiment actuators such as those shown in FIGS. 4 and 5 are used disclosed in U.S. Pat. No. 6,720,704 and WO03/090245 respectively. These have the advantage that gap 28 can be altered and reset if necessary to achieve maximum electron flow. Using actuating elements 60 as shown in FIG. 4, for controlling distance between the electrodes 28 avoids problems associated with electrode spacing changing or distorting as a result of heat stress. In addition it allows the operation of these devices at electrode separations which permit maximum quantum electron tunneling between them and thus efficient cooling. An advantage of a tubular actuator such as the one shown in FIG. 5, is that it serves both as actuator and as housing simultaneously. Housing provides mechanical strength together with vacuum sealing. External mechanical shock or vibrations hit the external housing first and are compensated immediately by actuator 50.

The position of actuators shown in FIGS. 4 and 5 may be arranged so that diode heat pump 16 may be directly attached to die 18. Appropriate configurations are known to those skilled in the art. It is understood that the present invention is not limited to the configurations shown above.

In a further embodiment of the present invention diode heat pump 16 is constructed using the process shown in FIG. 6 above. In the present invention after electrode 30 has been deposited directly onto die 18 electrode pair precursor sandwich 90 as shown in step 200 of FIG. 6 is constructed thereon. Sandwich 90 and die 18 thereby form a hybrid composite unit, with electrode 30 and die 18 being effectively integral. Sandwich 90 is then treated, removing sacrificial layer 82 so that sandwich 90 separates to form diode heat pump 16. Methods of forming and separating similar sandwiches are disclosed above and known to those skilled in the art. It is understood that the present invention is not limited to those methods.

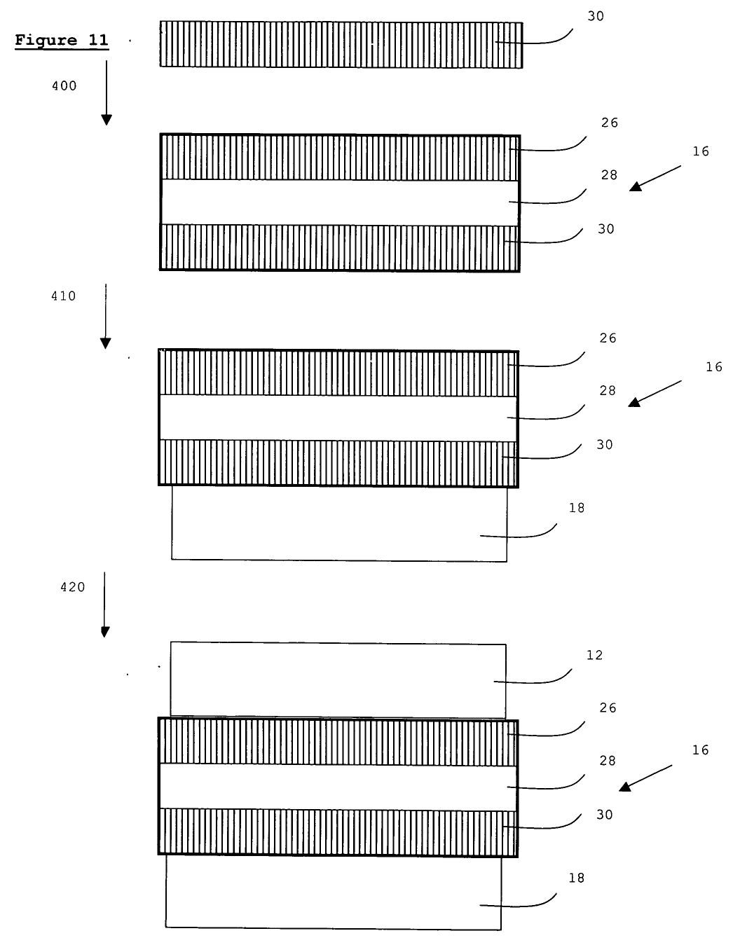

FIG. 11 shows a second embodiment of the present invention, in which diode heat pump 16 is attached to die 18 after each unit has been manufactured independently. In step 400 diode heat pump 16 is constructed comprising two electrodes 30 and 26 separated by a gap 28 through which electrons can tunnel. In step 410 completed diode heat pump 16 is attached to die 18 using vapor deposition techniques as disclosed above. In step 420 heat sink 12 is attached to diode heat pump 16 so that heat produced by die 18 can be pumped away.

Diode heat pump 16 may be as disclosed in FIG. 1 or further embodiments known to those skilled in the art may be used. It is understood that the present invention is not limited to those embodiments.

In one embodiment diode heat pump 16 may utilize modified electrode 40 disclosed in FIG. 2. Diode heat pump 16 is constructed utilizing modified electrode 40 as its first electrode and is then attached to die 18 as disclosed above.

Gap 28 may be maintained by spacers 48 as shown in FIG. 3 disclosed above. Alternatively actuators such as those shown in FIGS. 4 and 5 may be used.

Diode heat pump 16 may be constructed using techniques disclosed in U.S. Pat. No. 6,869,855 as shown in FIG. 6. Following step 200 in FIG. 6, in which sandwich 90 is constructed, sandwich 90 is deposited onto die 18 using vapor deposition techniques as disclosed. Sandwich 90 and die 18 thus form a hybrid composite unit. Sacrificial layer 82 is then removed, sandwich 90 is separated and diode heat pump 16 is formed. Further methods of forming diode heat pump 16 are known to those skilled in the art. It is understood that the present invention is not limited to those methods.

Direct deposition of diode heat pump 16 onto die 18 may result in a substantial reduction in temperature at the die 18/diode heat pump 16 interface. As a result, the leakage power consumption of die 18 may also be reduced. With a substantially increased cooling efficiency comes a decrease in temperature and hence a faster electronic device.

As disclosed, improvements in efficiency of the present invention are due to the combination of direct deposition onto die 18 and the use of a diode heat pump 16 as the cooling device. There are many possible embodiments of the present invention apparent to those skilled in the art. Some additional possible embodiments of diode heat pump 16 for further heat reduction and improvements in efficiency are disclosed as follows.

Using the techniques described herein, junction temperatures more than fifty percent lower than that achieved with conventional cooling techniques may be achieved in some embodiments. The temperature of the cold junction of thin film diode heat pump 16 may be much lower than that achieved with thermoelectric cooling with the same heat removal. For example, based on modeling, temperatures of approximately 50 degrees C. may be achieved. At such temperatures, the leakage power consumption of a processor such as die 18, may be significantly reduced.

Moreover, the savings in leakage power consumption may be sufficient to compensate for or to balance the power used for thermotunneling cooling. Thus, improved results may be achieved either without increasing or without substantially increasing the power consumption of a processor unit and cooling system. Furthermore, because a thermal interface material is dispensed with, the temperature of the surface of die 18 is effectively that of the junction of diode heat pump 16.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising the steps of:
a) providing a processor having one or more surfaces to be cooled;
b) forming a diode heat pump on said surface, said diode heat pump having two electrodes separated by a space.

2. The method of claim 1 wherein one or both of said electrodes comprise on its surface one or more indents of a depth less than approximately 10 nm and a width less than approximately 1 μm.

3. The method of claim 1 wherein said step of forming a diode heat pump comprises applying the following steps to each surface to be cooled:
a) depositing one or more layers of material over said surface to be cooled whereby a first layer furthest from said surface to be cooled is formed;
b) oxidizing a surface of said first layer whereby an oxidized layer is formed;
c) protecting selected areas of said oxidized layer, wherein said selected areas represent a minority of said oxidized layer;
d) removing areas of said oxidized layer which have not been protected, whereby said protected areas remain as protrusions; and
e) positioning one or more further layers of material substantially facing said first layer such that said protrusions maintain a gap between said layers of material at a distance whereby maximum thermotunneling or thermionic emission may occur between said layers.

4. The method of claim 3 whereby said step of depositing one or more layers of material over said surface additionally comprises depositing a layer nearest said surface to be cooled at an atomistic level whereby said layer nearest said surface and said surface of said processor are effectively integral.

5. The method of claim 4 wherein said step of depositing comprises a deposition step selected from the group consisting of: thin-film deposition techniques, molecular beam epitaxy, and metal organic chemical vapour deposition.

6. The method of claim 1 wherein said step of forming a diode heat pump comprises applying the following steps to each surface to be cooled:
a) fabricating on said surface an electrode pair precursor sandwich wherein said sandwich comprises a first layer of material for use as a first electrode, a sacrificial layer and a second layer for use as a second electrode
b) treating said sandwich wherein said treatment removes said sacrificial layer whereby a separation is formed at a distance wherein maximum thermotunneling or thermionic emission will occur between said first and said second layers of material.

7. The method of claim 1 wherein said step of forming a diode heat pump comprises applying the following steps to each surface to be cooled:
a) providing a processor;
b) fabricating an electrode pair precursor sandwich wherein said sandwich comprises a first layer of material wherein said first layer is a material suitable for use as a first electrode, a sacrificial layer and a second layer of material wherein said second material comprises a material that is suitable for use as a second electrode;
c) attaching said electrode pair precursor sandwich onto said processor; and
d) treating said electrode pair precursor sandwich deposited on said processor wherein said treatment removes said sacrificial layer whereby a separation is formed between said first and second electrodes at a distance wherein maximum thermotunneling or thermionic emission will occur between said electrodes.

8. The method of claim 1 further including the step of attaching actuating elements to said one or both electrodes such that the separation of the electrodes is controlled.

9. The method of claim 1 further including the step of attaching a heat sink to said diode device.

10. An electronic device comprising:
a) a processor having one or more surfaces to be cooled; and
b) a diode heat pump attached each of said one or more surfaces to be cooled;
wherein said diode heat pump and said processor form a hybrid composite unit.

11. The device of claim 10 wherein said diode heat pump comprises:
a) a plurality of electrodes having surfaces substantially facing one another,
b) a gap between said electrodes wherein distance of said gap allows maximum thermotunneling or thermionic emission.

12. The device of claim 10 wherein said diode heat pump comprises one or more layers having on one surface one or more indents of a depth less than approximately 10 nm and a width less than approximately 1 μm.

13. The device of claim 10 wherein said diode heat pump comprises:
a) a plurality of electrodes having surfaces substantially facing one another,
b) a respective spacer or plurality of spacers disposed between said electrodes to allow gaps between said electrodes, and where the surface area of the spacer or plurality of spacers in contact with said surfaces is less than the surface area of said surfaces.

14. The device of claim 10 further including means for controlling the distance separating the electrodes of said diode heat pump, connected to one or all of said electrodes.

15. The device of claim 14 wherein said means for controlling the distance separating said electrodes are selected from the group consisting of: piezo-electric, electrostrictive and magnetostrictive actuators.

16. The device of claim 10 further comprising a heat sink attached to said diode device.

17. The device of claim 10 further comprising a package coupled to said processor.
